(19) United States
(12) Patent Application Publication
(10) Pub. No.: US 2008/0267403 A1
(43) Pub. Date: Oct. 30, 2008

(54) System and method for privacy enhancement via adaptive cryptographic embedding

(75) Inventor: Terrance E. Boult, Monument, CO (US)

Correspondence Address: LAW OFFICE OF DALE B. HALLING, LLC, 655 SOUTHPOINTE CT, SUITE 100, COLORADO SPRINGS, CO, 80906, US

(73) Assignee: Regents of the Univeristy of Colorado

(21) Appl. No.: 11/983,698

(22) Filed: Nov. 9, 2007

Related U.S. Application Data
(60) Provisional application No. 60/858,140, filed on Nov. 9, 2006.

(51) Int. Cl. H04L 9/00

(52) U.S. Cl. 380/255

(57) ABSTRACT

The system and method enhances privacy and security by determining parts of a data stream that should not be publicly available and doing in-place encryption of that data while leaving the remaining data unencrypted for direct usage in security. The system is composed of a designator, that determines what parts of the data stream require protection, and a protector, that performs the in-place encryption. The resulting protected data stream can be played/displayed using the same standard technology as for the original data stream, with the encrypted portions appearing as random noise. The system also supports an extractor, which can, given access to the appropriate keys, invert the encryption and provide back the original data stream.

### RELATED APPLICATIONS

The present invention claims priority on provisional patent application Ser. No. 60/858,140, filed on Nov. 9, 2006, entitled “PICO: privacy through invertible cryptographic obscuration” and is hereby incorporated by reference.

### STATEMENT REGARDING FEDERALLY SPONSORED RESEARCH

Not Applicable

### THE NAMES OF THE PARTIES TO A JOINT RESEARCH AGREEMENT

Not Applicable

### REFERENCE TO A SEQUENCE LISTING, A TABLE, OR A COMPUTER PROGRAM LISTING

Not Applicable

### BACKGROUND OF THE INVENTION

This invention relates generally to photographic, video or audio recording, generally for surveillance or security concerns. Surveillance is becoming more and more common all over the world. People are forever under the watchful ‘eye’ of the camera even as they go through their day-to-day activities. CCTV, increasingly with audio recording, is widely used for surveillance in banks, parking lots, shopping malls, airports, and other public places. Electronic audio recording (wiretapping) is also a growing concern. In these applications there is tension and tradeoff between the privacy of those being recorded and the underlying goals of security.

There are many privacy issues in surveillance. While some “invasion” is unintentional, or even just potential, the personnel who are in-charge of scanning these video images are often either ignorant about their job or tend to misuse their powers, for example, engaging in voyeurism. While cameras in airports, school bathrooms or eldercare facility bathrooms might improve security or safety, the potential abuses prohibit their use.

In the prior art, in order to address privacy, techniques such as privacy masking or blurring have been proposed. In the prior art, either an opaque mask, external to the camera, is applied, or after capturing the data, the regions of concern are irrevocably transformed to protect the privacy. While effective for applications like videotaping for television, these techniques have less implication for privacy in surveillance. With these techniques, the portion of the video/audio information including “privacy sensitive” data is modified but the transforms render the resulting data significantly less useful for security purposes.

In other prior art, privacy is addressed by encrypting data. Generally the person who is concerned about privacy, protects the data by encrypting it. Encrypted phone or radio communication is a well established example of prior art. In general this protects privacy because it inhibits the ability of others to access the data, i.e. it inhibits surveillance.

### PROBLEMS WITH THE PRIOR ART

U.S. Pat. No. 6,067,399, issued to Berger on May 23, 2000 titled “Privacy mode for acquisition cameras and camcorders”, teaches a method of privacy enhancement wherein the system detects regions of skin in images, and modifies the corresponding pixels to obscure the subjects skin areas or face, either by direct pixel manipulation or graphics overlay. It teaches of protecting the privacy by ensuring that the identity cannot be recovered even from the original source data. It also teaches of distorting the audio channel to protect identity. European Patent EP 1 081 955 A2, issued to Koji et al. on Jul. 3, 2001 titled “Monitor Camera system and method of displaying picture from monitor thereof”, teaches of another method to determine and manipulate a “privacy region” which can obscure parts of an image as seen on camera. Again the distortions are non-invertible destruction of the data that might violate privacy.

US Patent 20050270371 A1, issued to Seblak on Dec. 12, 2005 titled “Transformable privacy mask for video camera images”, teaches of an adaptive pixel-wise obscuration approach to protect privacy.

US Patent 20060206911 A1, issued to Kim et. al. on Sep. 14, 2006, titled “Security camera employing privacy protection method”, teaches of an approach whereby a privacy area processor in the camera reduces the resolution, i.e. blurs, regions of the image to protect privacy.

An important aspect of all the aforementioned prior art is that the resulting audio/video data are protected in such a manner that the resulting data can be played/viewed without modification to existing display hardware/software. Unfortunately, they also cannot recover the original data.

US Patent 20030231769 A1, issued to Bolle et al, Titled “Application independent system, method, and architecture for privacy protection, enhancement, control, and accountability in imaging service systems” teaches of transforming the data of privacy interest by a range of techniques (destruction, modulation, overlay with graphical icon). The 20030231769 A1 patent teaches that “Some extracted information in video analysis stage is permanently obscured in the transformed methods”. It separates the descriptive information to be protected into various “tracks”, which can be separately encrypted with a range of keys. It requires an authorizer that provides authorization information with the image, the descriptive information in the transformed state is capable of being decoded only if one or more authorization inputs satisfy the authorization criteria. This method teaches of separating the data to be protected and encrypting some of it, but requires an added authorizer and specialized display/decoding components.

Partial encryption has been applied to protection of video data, where the goals are to reduce computational cost by encrypting only part of a data stream but selecting that portion so as to provide overall protection. U.S. Pat. No. 5,805,700 teaches selectively encrypting compressed video data based on policy. Specifically it teaches how to selectively encrypt the basic transfer units (BTU), start code of a GOP (group of pictures) or an I- P- B-frame in a MPEG-formatted video to achieve video image degradation with substantially less processing needed than using encryption of the full data stream. The '700 patent is based on structures of the MPEG-format and shows how, if key items are encrypted, the video cannot be effectively recovered. It does not address region-based encryption or any type of privacy protection. The objectives of using partial encryption in the '700 patent is to make as much of the data useless with minimal effort, not to leave the majority of data useful for security purposes.

U.S. Pat. No. 7,167,560 issued to H. H Yu, Titled “Partial encryption of stream-formatted media”, address partial encryption of streaming data, building on the recognition that the very same qualities of streaming media data that makes it useful, also make the data especially suited to a type of encryption that represents a significantly reduced computational load. Where the encryption-caused disruption is slight, the recipient will only be aware of a slight degradation in the quality of the media. But where the encryption is more significant, there comes a degree of disruption at which the media is rendered substantially imperceptible or of such low quality as to be substantially unsuitable to the recipient. Further, the degree of disruption at which the media becomes substantially imperceptible or substantially unsuitable to the recipient corresponds to partial encryption. The '560 patent teaches an approach such that more important information data layers are encrypted first and more securely while less important data layers are encrypted second and less securely, etc., thereby achieving scalability; multi-dimensional and multi-layered encryption capability to accommodate different application needs and/or to make different quality levels of preview available to different types of users (e.g., lower level with least clear data preview for general population, higher level preview with clearer data for club members, and full playback for authorized or paid customers); fine granularity scalable encryption for a fine granularity scalable coded media data stream especially useful in real time and streaming media applications.

What is lacking in the prior art is a technique that allows privacy protection, while simultaneously allowing security/surveillance to use as much of the data as possible, and to recover the original data if needed.

What is needed, and what present invention provides, is an approach which supports privacy yet still provides a security/surveillance value for the data. Furthermore, the invention does this in such a manner that existing media tools can still manipulate and play the data.

### BRIEF SUMMARY OF INVENTION

In one embodiment of the invention, for image or video based technologies the invention is applied by detecting a region of potential privacy concern, e.g. face, skin or even motion. These regions are then encrypted, in-place, producing an image that can be viewed with standard tools, but where the regions become apparently random data. The encryption can be either completely done using a public key encryption, or a symmetric encryption, e.g. AES128, can be used, or they can be combined with the AES key being encrypted with the public key, with the encrypted AES key and region definitions being stored as a comment or other field within the media stream, or even as invisible embedded watermark data. Using the private key and a special extraction tool, the original data can be recovered. For example, if the images were needed for criminal prosecution, the encrypted “face” data might be recovered. By allowing recovery of the original data, the invention provides for improved security, while still protecting privacy.

In another embodiment, various components of a digital audio channel are identified as needing privacy protection. Those segments are then subject to encryption and reinserted into the digital stream in-place of the original data. When listened to with traditional tools, the encoded data will appear as noise. The encryption can be either completely done using a public key encryption, or a symmetric encryption, e.g. 3DES, can be used and the DES key being encrypted with the public key, with the encrypted DES key being stored back within the media stream. The unencrypted components of the data can be listened to using standard tools and may provide important evidence for surveillance. If there is sufficient cause, the keys will again allow recovery of the original data using a special tool

A lossy compression, such as jpeg or mp3 applied to encrypted data, would result in data that would no longer support recovery of an approximation to the original data. In another embodiment, the digital regions to be privacy protected will be compressed or need to be compressed, and the encryption is applied to the compressed data, adjusting for any data boundaries needed to properly interact with the compression algorithms and data formats.

A more complete understanding of the present invention, as well as further features and advantages of the present invention, will be obtained by reference to the following detailed description and drawings.

### BRIEF DESCRIPTION OF THE SEVERAL VIEWS OF THE DRAWINGS

FIG. 1 is a flow chart showing the basic components of minimal embodiment of the privacy enhancing system.

FIG. 2 is a flow chart of the basic stages of a system that combines the privacy enhancement with compression.

FIG. 3 shows a hypothetical input image, the privacy region designated by face detection and the results of in-place block-based encrypted region.

FIG. 4 shows a hypothetical input image, the privacy regions designated by motion detection and the results of in-place block-based encryption regions.

FIG. 5 shows a flow chart of the steps in processing for in-place encryption during jpeg compression.

FIG. 6 shows the steps in one embodiment of key generation and storage.

FIG. 7 shows the stages in decrypting the protected data stream.

FIG. 8 shows the stages in a privacy enhanced half-tap for telephone communications.

FIG. 9 shows an example of half-tap usage, where a warrant is granted to decrypt the protected data stream.

### DETAILED DESCRIPTION OF THE INVENTION

The present invention provides for privacy enhanced security were the encrypted data is stored back into the data-stream such that preexisting display technologies, e.g. web browser or digital cameras, can decode and display the privacy protected data. There is no need for a separate authorizer, there is no destruction of data, no masking of data—rather the data is encrypted and reinserted into place as part of the image encoding process. In the various embodiments of this invention, the protected data is such that it can be decoded and viewed on any standard image/video display device. For example, a protected jpeg image would be viewable with a standard image viewer and the standard compliant jpeg image carries the encrypted data with it. Because of the spatially varying partial encryption, the data is still generally useful for security purposes. The protected data, and any necessary keys, can then be supplied to a separate recovery program to decrypt the protected region, e.g. to provide data for prosecution.

In the prior art, the data stream to be “protected” was transformed in a manner that permanently lost data. Because there was no need to preserve information, the transformation process was simply to apply, even if the data was later compressed. The in-place encryption of the proposed invention must be applied after any lossy compression, because lossy encryption would destroy some of the encrypted data, rendering recovery impossible.

Compared to the approach of the 20030231769 A1 Patent, the presentation invention does not require an authorizer as part of the processing, using instead predefined public keys, which is both an advantage and potential disadvantage. It is an advantage because of simplicity during encoding. It is a potential disadvantage because it reduces the privacy model as there is no image-specific authorization and the system cannot limit who is authorized to decode the image-whomever gains access to the appropriate keys can decrypt the data even if such key access was never unauthorized.

Another point of comparison of the proposed invention with the 20030231769 A1 Patent is that there is no separated data tracks. Separated tracks can provide for rapid analysis, indexing and searching. Separated tracks also simplify the handling of compressed data, which is never encrypted, and the encryption which is not subject to compression at later stages. However, using separated tracks is a disadvantage because the added data tracks also require non-standard display/transmission technology.

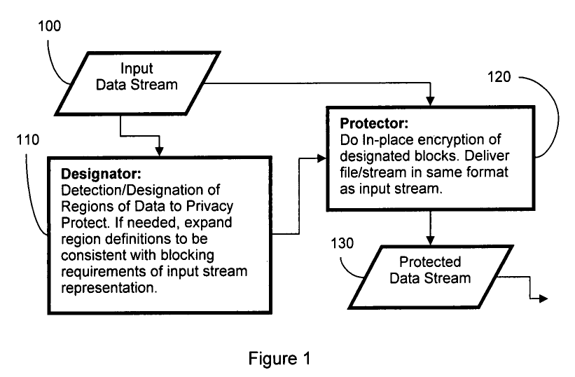

In FIG. 1, the basic 2-stage privacy enhancement process is described. An input stream (100) provides data to designator process (110). The designator process determines, by any of various means including face detection, skin detection, motion detection, object detection, or word recognition, the regions of the input data stream that require protection. If the input stream has particular structure, e.g. 8×8 blocks for compression, then the designator expands the region definitions to be consistent with those rules. If the input stream is compressed, designator may decompress it for analysis and may also have access to other data sources to provide motion or object detection abilities.

The input stream and the designated regions are then passed on to the protector (120). The undesignated blocks pass through the protector essentially unchanged, but for designated block(s) it provides for in-place encryption, i.e. it encrypts the data and places it back at essentially the same location relative to the original data stream to produce the protected stream (130). To do this, it required that the encryption process be such that the resulting data is consistent with the data formatting rules of the stream. In particular, if the input stream is a structured data format, e.g. a precompressed data source, with a combination of structure and data fields intermixed, then the encryption should be applied only to the data.

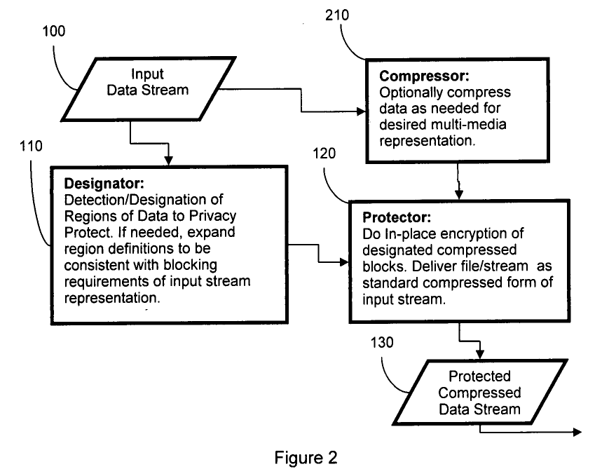

In some embodiments, it is desired to combine the privacy protection in a device that is also providing compression, e.g. a web-camera that is going from raw sensor data to a stream of compressed jpeg images. In this case, one could view the process as first compressing to produce the input stream (100) of FIG. 1, which may then require decompression for designation. A more efficient approach is to combine the compression as a separate stage as in FIG. 2. In this embodiment, the raw input is provided to the designator (110) as well as to the compressor (210). The designator then provides the list of regions to protect to the protector (120), which also takes as input the output of the compressor (210). If there are other constraints on data flow or processing, those skilled in the art will realize many such variations exist that could improve effectiveness of a particular implementation.

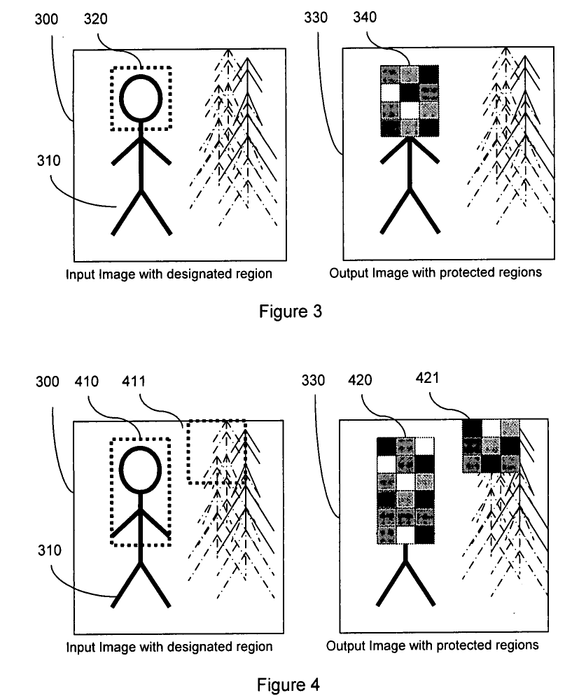

FIG. 3 shows an example of an input image (300) with a subject of interest (310) and other random elements in the image. A face-based designator (110) might designate a region of protection around the head (320). In the output image (330), the protected region (340) would be encrypted, generally appearing as a noisy region in the image. The remainder of the image would still be visible allowing security personnel to determine if the activity of the subject was somehow suspicious, e.g. if they were carrying a weapon in a restricted area.

FIG. 4 shows an alternative embodiment where the designator might detect all regions where there is significant motion (410, 411) and the output image would then be protecting these moving regions (420, 421). By encoding all regions that are moving, the system might improve privacy since the clothes a person wears might also provide data on their identity. The designation of regions might also include irrelevant regions (411) where there is no privacy implication in the data. The resulting encoded region (421) does not reduce privacy, but including too many such regions would reduce the security value of the data, eventually encrypting the entire image and providing no visible data for analysis. It is worth noting that the in-place encryption process can support multiple iterations of encryptions, e.g. the face region (320) might be encrypted in-place with one key, and the motion region (410) which happens to contain some of the same blocks, can still be applied. The blocks in common will be encrypted with both keys, and decryption of the face region (340) would first require decryption of the motion region (420).

A critical aspect of many embodiments of the invention is the handling of in-place encryption when using compressed data. We describe a preferred embodiment using JPEG images as the mode of compression, see Gregory K. Wallace, The JPEG Still Picture Compression Standard—IEEE Transactions on Consumer Electronics, Vol. 38, No. 1, February 1992. Those skilled in the art will recognize how to adapt the approach to other block or region-based compression schemes. We use the JPEG standard as our example because it is the most common compressed image format being used, and is commonly used in streaming web-cameras which produce MJPEG, a sequence of separately encoded JPEG images.

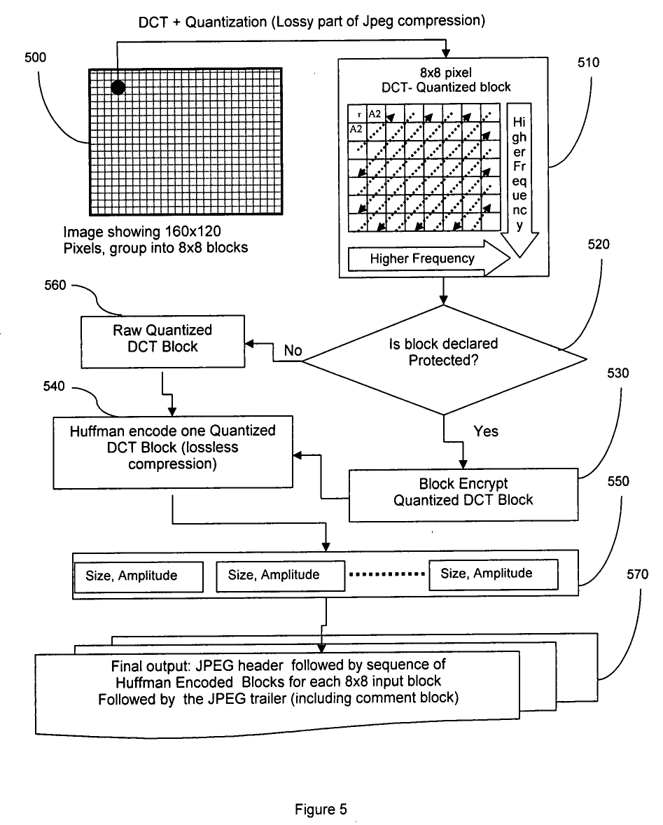

In one preferred embodiment, we take the approach of applying the encryption during the JPEG compression process just after the DCT quantization but before the lossless Huffman encoding. In FIG. 5, we see a sample image (500) that is subdivided into 8×8 pixel blocks. Each 8×8 block is subjected to the Discrete Cosine Transform and then quantization of the resulting coefficients. It is the quantization of these coefficients which defines the “lossy” nature of JPEG encoding. The quantized DCT coefficients are then scanned in a zigzag pattern, scanning from low to high-frequency. The result is quantized DCT data block (510). We then test (520) if this block is to be protected. If it is, we perform block encryption (530) on the quantized DCT data block and provide the results to the Huffman encoding process (540). If the test (520) determines this block does not need protection we provide the raw quantized DCT block (560) to the Huffman encoding process (540). The Huffman encoding process is a lossless compression, so the results after compression allow recovery of the exact data block. The Huffman block encoding produces a structure (550) with field sizes and magnitudes for each encoded coefficient. The final output (570) is a JPEG header followed by the Huffman encoded blocks, followed by the JPEG trailer (including comments). One cannot simply encrypt the results of the Huffman encoding of blocks to be protected because the standard display/decoding technology would then try to interpret data in the encrypted block, which would produce invalid sizes resulting in an improperly formatted file/stream. Those skilled in the art will recognize this lossy/lossless mixture of stages in other compression technology and how to apply this invention accordingly.

The final aspect of the process needs to address the encryption technologies and key management. There are many classes of encryption. A simple embodiment is well suited to personal devices such as cell phone or digital camera, or even a personal web-camera monitoring the home. The process uses a symmetric key encryption, such as the AES standard or DES standard, and generates the key by hashing a user-provided pass-phrase. The pass-phrase is should not be stored and would be reentered each time the device is used. This has the advantage of simplicity, but because of the symmetric nature of the encryption, we cannot securely store the key in the image. This embodiment is effective if the protected data is intended to be used by only a small number of individuals that can share the secret key.

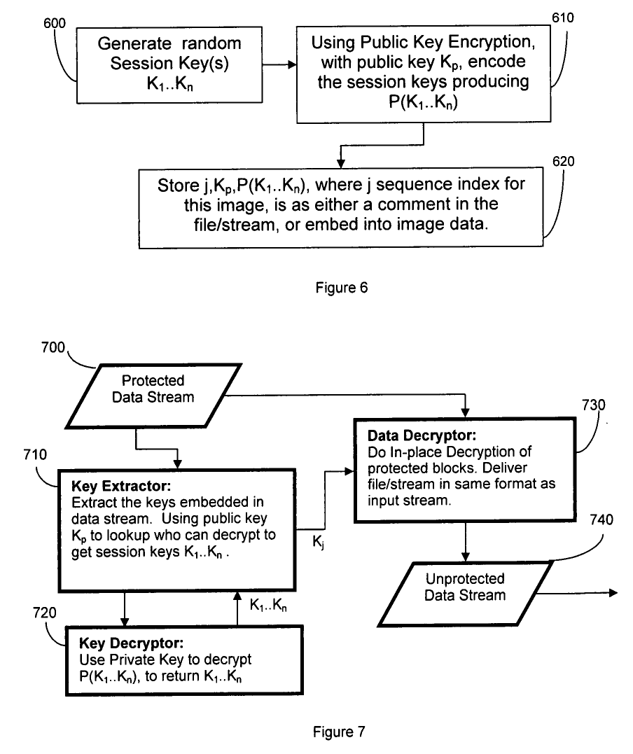

In another preferred embodiment, which provides for improved security and usability, we combine a public-key encryption with symmetric key technology. In FIG. 6, we show the basic process for key generation and storage. A sequence of random session keys, K₁ . . . Kₙ, are generated (600) and the collection of keys is then encrypted using a known public key Kₚ to produce P(K₁ . . . Kₙ,) (610). The sequence of keys might represent different designators and/or be used across a sequence of images. We may choose to group keys into larger key sequences because the public key encryption process is more expensive and has a minimum payload size for encryption, e.g. a RSA 1024 bit encryption always encrypts 1024 bits, so if there was only a single 128 bit key, we would have to pad it. By combining keys across frames we can do public key encryption less frequently, then embed a payload (620) into each frame consisting of sequence index j (unencrypted) the public key Kₚ (unencrypted) and the encrypted P(K₁ . . . Kₙ,). This is generally a small payload, which can be included either as a comment field if the data stream supports comments, or as a embedded data, e.g. using watermarking or steganographic techniques—see Tse-Hua Lan; Mansour, M. F.; Tewfik, A. H. “Robust high capacity data embedding.” in Image Processing, 2000. Proceedings. 2000 International Conference on Volume 1, Issue, 2000 Page(s):581-584 vol. 1. The comments fields, e.g. in jpeg, make it easy to locate and acquire the keys for decryption, but have the disadvantage that they are more easily destroyed/removed compared to a redundant watermark embedding.

In alternative embodiment, we also include a check sum or cryptographic hash of the original data so that we verify its validity when decoded. For simpler decoding of the regions, it can also be convenient to include in the embedded payload an indication of which regions that have been designated as protected. In JPEG streams, this can be done by including a thumbnail with a particular value for the protected regions.

The process of recovering the original data from the protected data is shown in FIG. 7. The protected data stream (700) is input to a key extractor (710) that retrieves the payload from either the comment fields or from the embedded watermark. Given the payload, the key extractor can use the public Key Kₚ and a key table, to look up what process/person would be the keeper of the associated private key. The key extractor can then provide the payload to the key decryptor (720) that decodes the session keys and provides them back to the key extractor. The key extractor then provides the appropriate key to the data decryptor (730) which does an in-place decryption of the data inserting it into the output stream to produce the unprotected stream (740). In embodiments where cryptographic hashes or other checksums are included, these would be checked on decryption to ensure proper keys were provided.

In an alternative embodiment, the data decryption is done as part of the standard jpeg decode and before the reconstruction of a non-compressed image for display. In this manner, an embedded device such as a cell phone, which can store the data and keys locally, can function as local viewer for the decrypted data.

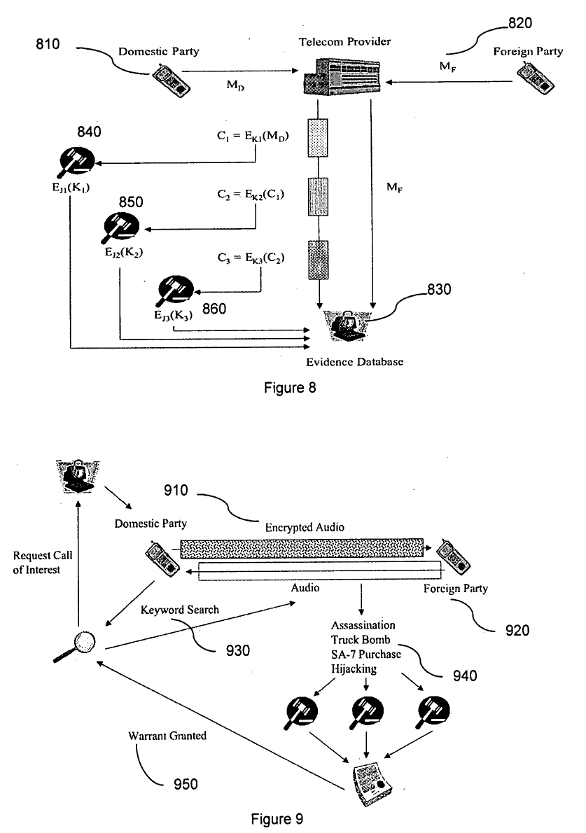

The invention can also be applied to non-image data, and a particularly interesting embodiment addresses audio recording or wiretapping. There has been growing concern about the US government's wiretapping of phone calls of American citizens without first obtaining a warrant. Some in the government have argued that the time required to obtain the warrant is unacceptable when listening in on potential terrorist phone calls. Acts such as CALEA, see Communications Assistance for Law Enforcement Act of 1994. Pub. L. No. 103-414, 108 Stat. 4279, already provide an infrastructure for telecom surveillance. By applying the invention, we can directly address, increasing privacy and security. The basic concept, which we call a half-tap, is show in FIG. 8. Because we consider the invasion of privacy in this example, with the potential for strong government influence, we have designed the process to have 3 separate key holders. The domestic voice channel (810) and foreign voice channel (820) are referred to as M_{D} and M_{F} respectively. As M_{F}, is foreign data and not subject to US privacy rules, it is passed in the clear (unencrypted) form to a central evidence database (830), while M_{D} is subject to multiple rounds of encryption. In this example, three AES session keys (K₁, K₂, and K₃) are generated, and used to encrypt M_{D} three times (540,550,560). Each of the three session keys is then encrypted using a public key associated with a different judge, and the three encrypted session keys are stored in the database with the final encrypted form C₃ of the domestic data. Thus, if M_{D} is to be obtained, three judges must consent to grant a warrant. Alternative embodiments might not encrypt the entire domestic call, but rather have a real time keyword recognizer running and encrypt everything except words within a prescribed distance of important keywords.

The process for obtaining a warrant aids the intelligence analyst considerably. With half the communication available, the probability of finding compelling evidence if the call is truly suspicious is high. FIG. 9 shows this process, with a domestic call (910) encrypted and the foreign call (920) unencrypted. A keyword search (930) is applied to the foreign party's unencrypted audio channel. If suspicious terms are found (940), an appeal can be made to the judges, who will decide if a warrant (950) should be granted to decrypt the domestic half of the call. If the warrant is granted, each provides the decryption of their associated session key, and the three session keys allow recover of the original domestic call. In this process there are no prior authorizations needed and there does not need to be any missed data—the half-tap recording can be done as desired. This process enhances security while preserving the privacy guaranteed by the law.

In summary, the invention provides for determination of data needing privacy protection and for the in-place encryption of that data, even under compression, such that standard display/playback mechanisms can use the protected data streams and provide information useful for security. The protected data can, with access to the appropriate private keys, be restored to the original form, further improving security.

The methods described herein can be implemented as computer-readable instructions stored on a computer-readable storage medium that, when executed by a computer, will perform the methods described herein. The methods can also be implemented as circuits embodied in photo, video or audio processing hardware, which increases the overall security since there is reduced opportunity to access the data before encryption.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A method of privacy enhancement for surveillance, comprising the steps of:
designating a region of a data in an input data stream;
encrypting the region of data, in place within said input data stream, to form a protected data stream; and
playing the protected data stream.

2. The method of claim 1, wherein the step of designating further includes the step of compressing the input data stream to form a compressed data stream.

3. The method of claim 1, wherein the input data stream is in compressed form.

4. The method of claim 3, further including the step of encrypting the region of data in the compressed data stream to form the protected data stream.

5. The method of claim 1, wherein the step of encrypting include storing an encryption key in a comment field of the protected data stream.

6. The method of claim 1, wherein the step of encrypting includes storing an encryption key as embedded data.

7. The method of claim 6, wherein the step of storing includes storing the encryption key using a watermarking technique.

8. The method of claim 6, wherein the step of storing includes storing the public key using a steganographic technique.

9. The method of claim 1, wherein the step of encrypting include storing a check sum of an original data of the region.

10. A system of privacy enhancement for surveillance, comprising:
a designator receiving an input data stream and defining a region of data to privacy protect;
a protector receiving the input data stream and the region of data and encrypting in place the region of data to form a protected data stream.

11. The system of claim 10, further including a compressor receiving the input data stream to form a compressed data stream.

12. The system of claim 11, wherein the protector encrypts the region of data in the compressed data stream to form the protected data stream.

13. The system of claim 12, further including a standard player playing the protected data stream.

14. The system of claim 10, wherein the protector stores an encryption key in the protected data stream.

15. A method of privacy enhancement for surveillance, comprising the steps of:
designating a region of a data in an input data stream;
encrypting the region of data to form a protected data stream; and
playing the protected data stream using a standard player.

16. The method of claim 15, wherein the step of designating includes the steps of:
determining if the region of data requires expanding to be consistent with a blocking requirement;
when the region of data requires expanding to be consistent with a blocking requirement, designating an expanded region.

17. The method of claim 16, further including the steps of encrypting the expanded region to form the protected data stream.

18. The method of claim 15, wherein the step of encrypting includes the step of storing an encryption key in the protected data stream.

19. The method of claim 15, wherein the step of encrypting includes the steps of:
compressing the input data stream to form a compressed data stream;
receiving the region of data and the compressed data stream at the protector;
encrypting the region of data in the compressed data stream to form the protected data stream.

20. The method of claim 15, further including the steps of:
extracting an encryption key from the protected data stream;
receiving a decryption key;
decrypting the protected data stream in-place to regenerate the input data stream.
